(19) United States
(12) Patent Application Publication
(10) Pub. No.: US 2026/0193061 A1
(43) Pub. Date: Jul. 9, 2026

(54) ELEVATOR CONSTRUCTION ARRANGEMENT AND A METHOD

(71) Applicant: Kone Corporation, Helsinki (FI)

(72) Inventors: Matti RÄSÄNEN, Helsinki (FI); Mika IJÄS, Helsinki (FI); Mikko KUKKOLA, Helsinki (FI); Markku HAAPANIEMI, Helsinki (FI)

(73) Assignee: Kone Corporation, Helsinki (FI)

(21) Appl. No.: 19/555,412

(22) Filed: Mar. 3, 2026

Related U.S. Application Data
(63) Continuation of application No. PCT/EP2023/078792, filed on Oct. 17, 2023.

(51) Int. Cl. B66B 19/00; B66B 19/02

(52) U.S. Cl. CPC B66B 19/005; B66B 19/002; B66B 19/02

(57) ABSTRACT

The elevator construction arrangement comprises: a hoistway; an elevator car, a counterweight, car guide rails for guiding the car, counterweight guide rails for guiding the counterweight; an elevator hoisting machinery and a suspension roping arranged to suspend the elevator car and the counterweight during construction time use of the elevator; a first rope terminal and a second rope terminal for supporting the suspension roping; and a motor module comprising a motor bed, the elevator hoisting machinery mounted on the motor bed; and during construction time use of the elevator, the motor module is mounted on a fixing bracket supporting a plurality of said guide rails; wherein said plurality of guide rails are adapted to pass through the motor module; and the motor module is hoistable through one or more fixing brackets in connection with an elevator jump. A method for installing elevator guide rails during construction of a building.

### CROSS-REFERENCE TO RELATED APPLICATION

This application is a continuation of PCT International Application No. PCT/EP2023/078792 which has an International filing date of Oct. 17, 2023, the entire contents of which are incorporated herein by reference.

### FIELD OF THE INVENTION

The invention relates to an elevator construction arrangement and a method for installing elevator guide rails during construction of a building.

### BACKGROUND OF THE INVENTION

The construction of an elevator may especially in high-rise buildings be done in parts along the height of the hoistway. The guide rails and the landing doors may first be installed to a first height in the hoistway, then to a second height etc. A construction time elevator may then be operated on the already installed lower portion of the hoistway while the construction of the elevator is going on in a higher portion of the hoistway.

EP4122865A1 discloses an elevator system in a hoistway of a building according to the preamble of claim 1.

### SUMMARY OF THE INVENTION

An object of the present invention is to present an improved elevator construction arrangement and an improved method for installing elevator guide rails during construction of a building.

A particular object of the present invention is to enable elevator installation to be continued above a driving elevator wherein the elevator machinery is mounted on a motor bed fixed on elevator guide rails such as a car guide rail and two counterweight guide rails.

A particular object of the present invention is to allow guide rails to be passed through the motor bed and to allow a motor module to be hoisted through a fixing bracket for the guide rails.

It is brought forward a new elevator construction arrangement according to claim 1.

It is also brought forward a new method according to claim 8.

The elevator construction arrangement comprises:

a hoistway;

an elevator car, a counterweight, car guide rails for guiding the car, counterweight guide rails for guiding the counterweight;

an elevator hoisting machinery and a suspension roping arranged to suspend the elevator car and the counterweight during construction time use of the elevator;

a first rope terminal and a second rope terminal for supporting the suspension roping; and

a motor module comprising a motor bed, the elevator hoisting machinery mounted on the motor bed; and

during construction time use of the elevator, the motor module is mounted on a fixing bracket supporting a plurality of said guide rails; wherein

said plurality of guide rails are adapted to pass through the motor module.

The elevator construction arrangement is characterized in that the motor module is hoistable through one or more fixing brackets in connection with an elevator jump.

According to an embodiment, said plurality of guide rails are adapted to pass through the motor bed.

According to an embodiment, projections of said plurality of guide rails are adapted to pass through the motor bed.

According to an embodiment, the motor module comprises guide elements, such as guide shoes or guide rollers, to guide the motor module in a controlled manner along the counterweight guide rails when hoisted.

According to an embodiment, the motor module comprises horizontal displacement means enabling horizontal movement of the motor bed relative to the fixing bracket and adapting the motor module to fit inside an open cross section between the fixing bracket and a wall of the hoistway.

According to an embodiment, the motor module comprises an upwards rotatable front part enabling adapting the motor module to fit inside open cross section between the fixing bracket and a wall of the hoistway, and preferably the rotational displacement of the front part is provided by means of a hinge.

According to an embodiment, the motor bed forms a continuous connecting surface between lower and upper car guide rails, to be replaced by a compensating guide rail section having a length corresponding to the height of the motor bed when the elevator jump is made.

According to an embodiment, the compensating guide rail section of the vertical length of the motor bed is attached to the motor bed when the elevator is driving below the motor module.

According to an embodiment, the guide rails below and above the motor bed are adapted to be connected to each other through the motor bed when the elevator is driving below the motor module.

According to an embodiment, a material hoist or equivalent hoisting device operating from upward direction is configured to hoist the motor module upwards in connection with the elevator jump.

According to an embodiment, the hoisting roping comprises plurality of ropes, which are preferably PU-coated.

According to an embodiment, the hoisting roping comprises PU-coated round ropes or PU-coated belts.

According to an embodiment, the motor module comprises the second rope terminal, which is preferably supported by the motor bed.

According to an embodiment, the second rope terminal is arranged to act together with a suspension roping suspension wheel, which is preferably supported by the motor bed.

According to an embodiment, the second rope terminal comprises an automatic rope lock device allowing opening and locking the second rope terminal to feed more belt or rope through the second rope terminal.

According to an embodiment, the automatic rope lock device is adapted to keep all ropes of the suspension roping the same length and at a constant tension.

According to an embodiment, downwards from the second rope terminal the suspension roping is arranged to pass to suspension roping reels, preferably located at a building floor or at the bottom of the hoistway.

According to an embodiment, after finishing the final height of the hoistway, the motor bed is adapted to be mounted above the guide rails.

The method for installing elevator guide rails during construction of a building comprises:

providing a hoistway, an elevator car, a counterweight, car guide rails for guiding the car, counterweight guide rails for guiding the counterweight;

arranging an elevator hoisting machinery and a suspension roping to suspend the elevator car and the counterweight during construction time use of the elevator;

supporting by a first rope terminal and a second rope terminal the suspension roping;

providing a motor module comprising a motor bed, the elevator hoisting machinery mounted on the motor bed; wherein

passing a plurality of guide rails through the motor module;

during construction time use of the elevator, supporting said plurality of guide rails by a fixing bracket on which the motor module is mounted.

The method is characterized in that in connection with an elevator jump, hoisting the motor module through one or more fixing brackets.

According to an embodiment, the method comprises passing a plurality of guide rails through the motor bed.

According to an embodiment, the method comprises passing projections of said plurality of guide rails through the motor bed.

According to an embodiment, the method comprises guiding the motor module comprising guide elements, such as guide shoes or guide rollers, in a controlled manner along the counterweight guide rails when hoisted.

According to an embodiment, the method comprises moving the motor module comprising horizontal displacement means enabling horizontal movement of the motor bed relative to the fixing bracket and adapting the motor module inside an open cross section between the fixing bracket and a wall of the hoistway.

According to an embodiment, the method comprises rotating an upwards rotatable front part comprised by the motor module and adapting the motor module to fit inside open cross section between the fixing bracket and a wall of the hoistway.

According to an embodiment, the method comprises replacing a continuous connecting surface between lower and upper car guide rails formed by the motor bed by a compensating guide rail section having a length corresponding to the height of the motor bed when the elevator jump is made.

According to an embodiment, the method comprises connecting the guide rails below and above the motor bed to each other through the motor bed when the elevator is driving below the motor module.

According to an embodiment, the method comprises, in connection with the elevator jump, hoisting the motor module upwards by a material hoist or equivalent hoisting device operating from upward direction.

According to an embodiment, the method comprises hoisting the second rope terminal together with the motor module, the second rope terminal being preferably supported by the motor bed.

According to an embodiment, the method comprises feeding more belt or rope through the second rope terminal comprising an automatic rope lock device allowing opening and locking the second rope terminal.

According to an embodiment, the method comprises keeping by the automatic rope lock device all ropes of the suspension roping the same length and at a constant tension.

According to an embodiment, the method comprises passing the suspension roping downwards from the second rope terminal to suspension roping reels, preferably located at a building floor or at the bottom of the hoistway.

According to an embodiment, the method comprises mounting the motor bed above the guide rails after finishing the final height of the hoistway.

### BRIEF DESCRIPTION OF THE DRAWINGS

The invention will in the following be described in greater detail by means of preferred embodiments with reference to the attached drawings, in which:

FIGS. 1 and 2 show details of an elevator construction arrangement, in which an elevator machinery is mounted on a motor bed fixed on elevator guide rails such as a car guide rail and two counterweight guide rails,

FIGS. 3 and 4 show an elevator motor bed fixed on top of a car guide rail and two counterweight guide rails,

FIGS. 5 and 6 show details of an elevator construction arrangement, in which guide rails pass through the motor bed and allow a motor module to be hoisted through a fixing bracket for the guide rails,

FIG. 7 shows a side view of a motor module hoistable upwards supported on counterweight guide rails, and

FIGS. 8 and 9 show embodiments for replacing the motor bed 10 with a guide rail section.

### DETAILED DESCRIPTION

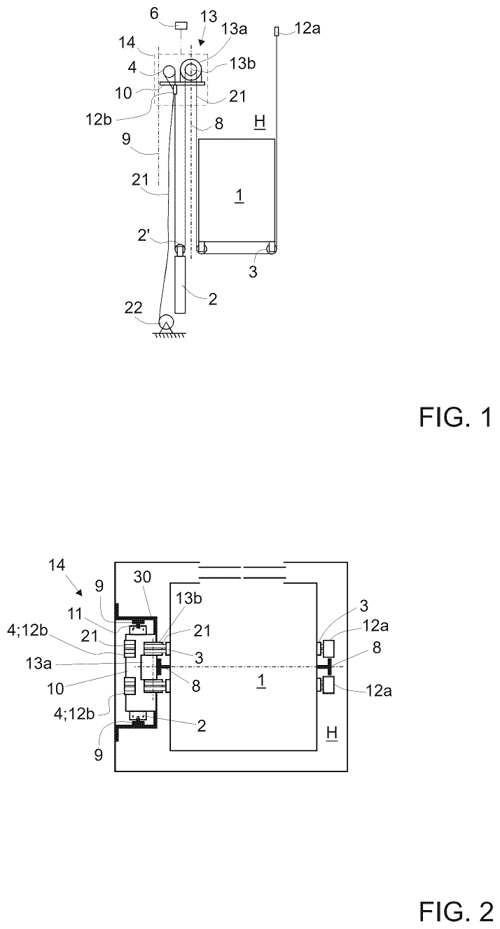

FIGS. 1 and 2 show an elevator in an elevator construction arrangement with an elevator car 1 and a counterweight 2 arranged vertically movable in a hoistway H. The elevator car 1 and the counterweight 2 are suspended with a hoisting roping 21 passing around a drive wheel 13b of an elevator hoisting machinery 13.

The machinery 13 is mounted on a motor bed 10 fixed on elevator guide rails such as a car guide rail 8 and two counterweight guide rails 9. The motor bed 10 is mounted on a fixing bracket 30 shown in FIG. 2 supporting a plurality of said guide rails 8, 9.

The counterweight guide rails 9 are mounted opposite each other inside the fixing bracket 30, and one car guide rail 8 is mounted on the outer side of the fixing bracket 30.

FIG. 1 illustrates preferred details of how the roping 21 passes. The roping 21 is arranged to pass from a first rope terminal 12a downwards to the elevator car 1, around one or more rope wheels 3 of the car 1, upwards to a motor module 14 comprising the machinery 13, around the drive wheel 13b thereof, downwards to the counterweight 2, around one or more rope wheels 2′ of the counterweight 2, upwards to a second rope terminal 12b.

According to an embodiment the second rope terminal 12b is used at least temporarily during the elevator construction and may be replaced by a final second rope terminal for the elevator final use.

According to an embodiment the second rope terminal 12b is arranged to act together with a suspension roping suspension wheel 4. According to an embodiment the hoisting roping 21 is arranged to pass from the second rope terminal 12b upwards to said suspension wheel 4, around the suspension wheel, and back to the second rope terminal 12b.

According to an embodiment, downwards from the second rope terminal 12b the roping 21 is arranged to pass to suspension roping reels 22.

According to an embodiment the second rope terminal 12b comprises an automatic rope lock device allowing opening and locking the second rope terminal 12b to feed more belt or rope through the second rope terminal 12b when the driving height of the construction time construction time use CTU elevator is to be extended. According to an embodiment wedges of the second rope terminal 12b are opened and locked in the feeding process of belt or rope through the second rope terminal 12b.

During the jump, the rope wedges of the automatic rope lock device are opened and the ropes are allowed to run through the automatic rope lock device while the machinery 13 and the motor bed 10 are lifted upwards. The excess ropes 21 run inside the fixing brackets 30 between the counterweight and the wall to rope reels 22. Once the machinery and the automatic rope lock device have been raised to the next position, the rope wedges are locked and the car and first rope terminal 12a are moved to the final position.

According to an embodiment the automatic rope lock device is adapted to keep all ropes of the suspension roping 21 the same length and at a constant tension.

When the automatic rope lock device is hoisted at the same time as the machinery 13, it is easy to control the automatic lock during hoisting, only the required amount of ropes is increased in the system during hoisting, and a faster jump time is achieved.

During the hoisting process, all ropes remain the same length and at a constant tension, which is very important for urethane-coated ropes.

According to an embodiment belt or rope reels 22 for the extendable hoisting roping 21 are located at a building floor or at the bottom of the hoistway H.

The motor module 14 comprising the motor bed 10 and the elevator hoisting machinery 13 mounted on the motor bed 10, forming preferably an integral hoistable unit, is hoistable through the fixing bracket 30.

According to an embodiment the motor module 14 comprises the second rope terminal 12b.

According to an embodiment the motor module 14 comprises the hoisting roping suspension wheel 4.

According to an embodiment the machinery 13, the suspension wheel 4 and the second rope terminal 12b are supported by the motor bed 10.

The motor module 14 is attached to the guide rails 8, 9 during construction time use of the elevator. According to an embodiment the motor module 14 is also attached to the hoistway wall.

According to an embodiment the motor module 14 comprises guide elements 11 such as guide shoes or guide rollers to guide the motor module 14 in a controlled manner along the counterweight guide rails 9 when hoisted. According to an embodiment the motor bed 10 comprises said guide elements 11.

According to an embodiment a material hoist or equivalent hoisting device 6 operating from upward direction is used for hoisting the motor module 14 upwards in connection with an elevator jump.

The hoisting roping 21 preferably comprises plurality of ropes, which are preferably belt shaped.

According to an embodiment the ropes are PU-coated, preferably PU-coated round ropes or PU-coated belts having significantly better friction properties than conventional steel ropes without polyurethane coating.

Belts can only be bent in one direction, so the counterweight 2 is located on the side of the car 1, centrally behind the car guide rail 8, in the machine room less elevator solutions shown in the Figures.

The elevator car 1 is arranged to be vertically movable in the hoistway H along the car guide rail lines 8, and the counterweight 2 is arranged to be vertically movable in the hoistway H along the counterweight guide rail lines 9.

The machinery 13 for driving the hoisting roping 21 comprises a motor 13a and a drive wheel 13b, wherein the motor 13a is preferably an electric motor. The motor bed 10 comprises a horizontal beam.

According to an embodiment, after finishing the final height of the hoistway H, the motor bed 10 is arranged above the guide rails 8,9. This facilitates a reliable and simple ability to carry via the motor bed a big weight. Hereby, for example harmfully big torques in mechanical connections between parts can be avoided.

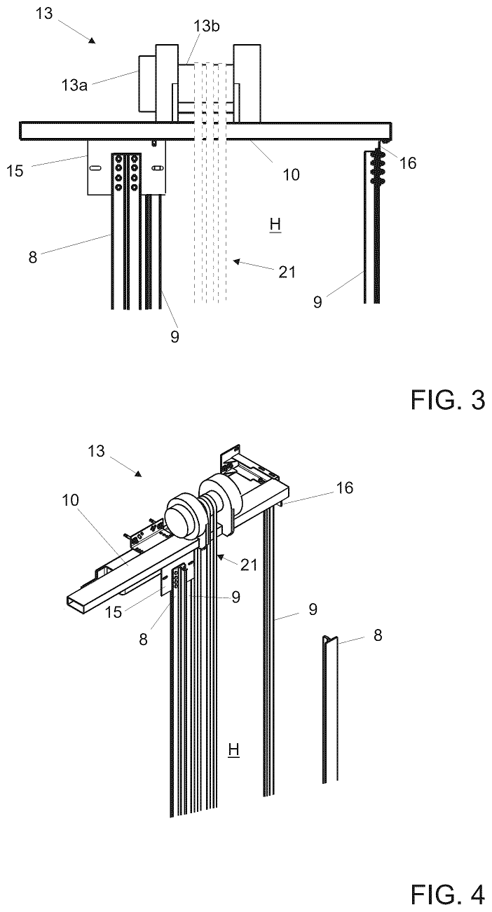

FIGS. 3 and 4 show principle of an elevator where the machinery 13 is mounted on the motor bed 10 fixed on top a car guide rail 8 and two counterweight guide rails 9 in an uppermost location of the hoistway H.

In FIGS. 3 and 4, the motor bed 10 is fixed to the upper ends of the guide rail sections 8,9. In the embodiment illustrated, the motor bed 10 is fixed to the upper end of each of the guide rail sections 8,9 by a fixing bracket 15; 16. This is more particularly implemented such that the upper end of each of the guide rail sections 8,9 is immovably fixed to a fixing bracket 15,16 immovably fixed to the motor bed 10. Providing support for the motor bed 10 by the car guide rail 8 and two counterweight guide rails 9 provides a substantially stable support and reduces weight to be carried per guide rail section. Implementing this by mounting the machinery 13 on the motor bed 10 mounted on said guide rails 8, 9 provides that the advantages related to stability and bearing abilities of the guide rails are achieved with relatively good freedom to position the machinery.

In order to continue the elevator installation above the driving elevator in which the machinery 13 is mounted on the motor bed 10 fixed on elevator guide rails such as the car guide rail 8 and two counterweight guide rails 9, new motor bed solutions are presented in the following.

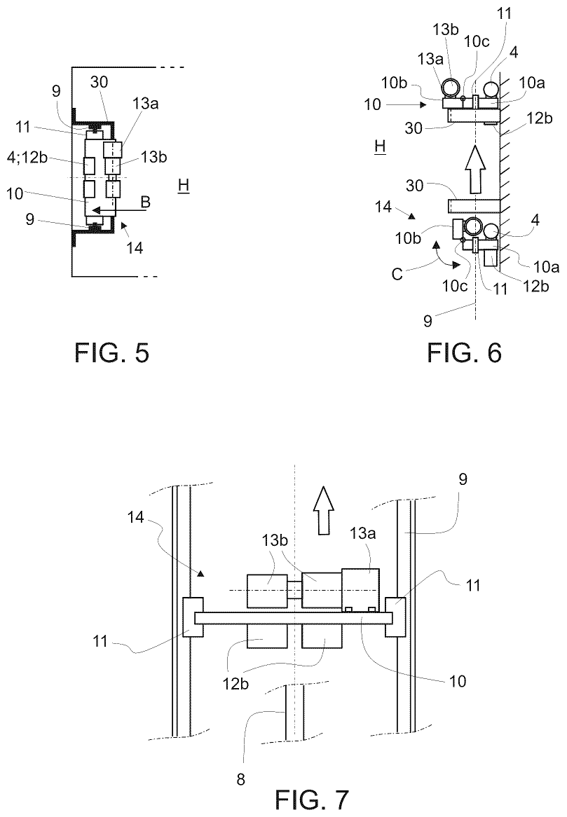

FIGS. 5, 6 and 7 show details of an elevator construction arrangement, in which guide rails 8, 9 pass through the motor bed 10 and allow the motor module 14 to be hoisted through the fixing bracket 30 for the guide rails 8, 9.

By the terminology that said plurality of guide rails 8, 9 passes through the motor module 14 and/or through the motor bed 10 is meant that a guide rail projection of at least one of said plurality of guide rails 8, 9 is adapted to pass through the motor module/the motor bed.

In the elevator construction arrangement, the motor bed 10 is configured in such a way that the guide rails can be connected through the motor bed.

When the elevator is in construction time use, the drive wheel 13b is placed on top of a common fixing bracket 30 for the guide rails 8, 9.

According to an embodiment the motor module 14 comprises horizontal displacement means B enabling horizontal movement of the motor bed 10 relative to the fixing bracket 30. The horizontal displacement means enable adapting the motor module to fit inside an open cross section between the fixing bracket and a wall of the hoistway H.

As preparation for hoisting, according to the embodiment shown in the top view of FIG. 5, the motor bed 10 of the motor module 14 with the machinery 13 is moved in relation to the fixing bracket 30 and the guide elements 11, horizontally inwards B inside the fixing bracket 30, in other words, inside the open cross section between the fixing bracket 30 and a wall of the hoistway H. Thereafter the motor module 14 is hoisted in a controlled manner upwards supported by guide elements 11 guided by the counterweight guide rails 9.

According to an embodiment the motor module 14 comprises an upwards rotatable part 10b enabling adapting the motor module 14 to fit inside the open cross section between the fixing bracket 30 and a wall of the hoistway H.

As preparation for hoisting, according to the embodiment shown in the side view of FIG. 6, a part of the motor module 14 comprising a front part 10b of the motor bed 10 with the motor 13a and the drive wheel 13b is rotated upwards C inside the open cross section between the fixing bracket 30 and a wall of the hoistway H. According to an embodiment the front part 10b of the motor bed 10 is rotated to an upward position relative to a rear part 10a of the motor bed 10 by means of a hinge 10c.

According to an embodiment, the solutions described with FIGS. 5 and 6 can also be combined, so that the motor module 14, guided along the counterweight guide rails 9, can be hoisted through the fixing bracket 30.

According to an embodiment the motor module 14 comprises horizontally movable means B enabling horizontal movement of the motor bed 10 relative to the fixing bracket 30, and the motor module 14 comprises an upwards rotatable part 10b enabling adapting the motor module 14 to fit inside open cross section between the fixing bracket and the wall of the hoistway.

One option is to move the machinery 13 with roping 21 and the motor bed 10 separately through the fixing bracket 30 to the next jump floor.

FIG. 7 shows a side view of motor modules 14, illustrated in FIGS. 5 and 6, hoistable upwards supported on counterweight guide rails 9.

The motor bed 10 solutions shown in FIGS. 5-7 can be used for an elevator jump above the driving elevator. The guide rails 8, 9 can be passed through the motor bed 10. The motor module 14 can be hoisted inside the guide rail fixing bracket 30.

The guide rails below and above the motor bed 10 can be connected to each other through the motor bed when the elevator is driving below the motor module 14.

According to an embodiment, a motor bed 10 forms a continuous connecting surface between the lower and upper guide rails 8, which is replaced by a compensating guide rail section 8c when the elevator jump, in other words, the motor module 14 jump is made.

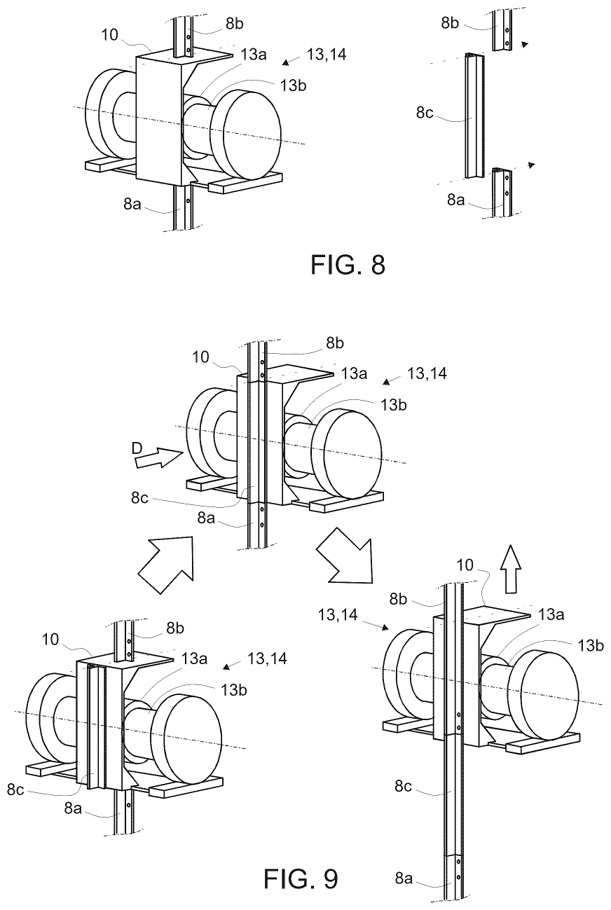

FIGS. 8 and 9 show two embodiments for replacing the motor bed 10 with a guide rail section 8c. The compensating guide rail section 8c has a length corresponding to the height of the motor bed 10.

According to an embodiment shown in FIG. 8, the motor bed 10 with its machinery 13 is removed between a lower guide rail section 8a and an upper guide rail section 8b. A compensating guide rail section 8c of the vertical length of the motor bed 10 is installed between the upper 8a and lower 8b guide rail sections.

According to an embodiment shown in FIG. 9, the motor bed 10 with its machinery 13 is moved out D between the upper 8a and lower 8b guide rail sections. Thereby a compensating guide rail section 8c of the vertical length of the motor bed 10 attached to the motor bed 10 is moved and inserted between the lower guide rail section 8a and the upper guide rail section 8b. Thereafter the motor module 14 can be hoisted upwards.

According to an embodiment the car guide rails 8 and the counterweight guide rails 9 below and above the motor bed are adapted to be connected to each other through the motor bed 10 when the elevator is driving below the motor module 14.

According to the method or installing elevator guide rails during construction of a building, a plurality of guide rails 8, 9 is passed through the motor bed 10; during construction time use of the elevator, said plurality of guide rails is supported by the fixing bracket 30 on which the motor module 14 is mounted; and in connection with the elevator jump, the motor module is hoisted through the fixing bracket.

It will be obvious to a person skilled in the art that, as the technology advances, the inventive concept can be implemented in various ways. The invention and its embodiments are not limited to the examples described above but may vary within the scope of the claims.

1. An elevator construction arrangement comprising
a hoistway;
an elevator car, a counterweight, car guide rails for guiding the car, counterweight guide rails for guiding the counterweight;
an elevator hoisting machinery and a suspension roping arranged to suspend the elevator car and the counterweight during construction time use of the elevator;
a first rope terminal and a second rope terminal for supporting the suspension roping; and
a motor module comprising a motor bed, the elevator hoisting machinery mounted on the motor bed; and
during construction time use of the elevator, the motor module is mounted on a fixing bracket supporting a plurality of said guide rails; wherein
said plurality of guide rails are adapted to pass through the motor module;
wherein the motor module is hoistable through one or more fixing brackets in connection with an elevator jump.

2. The arrangement according to claim 1, wherein said plurality of guide rails or projections of said plurality of guide rails are adapted to pass through the motor bed.

3. The arrangement according to claim 1, wherein the motor module comprises:
guide elements, such as guide shoes or guide rollers, to guide the motor module in a controlled manner along the counterweight guide rails when hoisted; and/or
horizontal displacement means enabling horizontal movement of the motor bed relative to the fixing bracket and adapting the motor module to fit inside an open cross section between the fixing bracket and a wall of the hoistway; and/or
an upwards rotatable front part enabling adapting the motor module to fit inside open cross section between the fixing bracket and a wall of the hoistway, and preferably the rotational displacement of the front part is provided by means of a hinge.

4. The arrangement according to claim 1, wherein the motor bed forms a continuous connecting surface between lower and upper car guide rails, to be replaced by a compensating guide rail section having a length corresponding to the height of the motor bed when the elevator jump is made; and
preferably the compensating guide rail section of the vertical length of the motor bed is attached to the motor bed when the elevator is driving below the motor module.

5. The arrangement according to claim 1, wherein a material hoist or equivalent hoisting device operating from upward direction is configured to hoist the motor module upwards in connection with the elevator jump.

6. The arrangement according to claim 1, wherein the hoisting roping comprises plurality of ropes, which are preferably PU-coated; and preferably the hoisting roping comprises PU-coated round ropes or PU-coated belts.

7. The arrangement according to claim 1, wherein the motor module comprises the second rope terminal, which is preferably supported by the motor bed; and/or
the second rope terminal is arranged to act together with a suspension roping suspension wheel, which is preferably supported by the motor bed; and/or
the second rope terminal comprises an automatic rope lock device allowing opening and locking the second rope terminal to feed more belt or rope through the second rope terminal.

8. A method for installing elevator guide rails during construction of a building comprising
providing a hoistway, an elevator car, a counterweight, car guide rails for guiding the car, counterweight guide rails for guiding the counterweight;
arranging an elevator hoisting machinery and a suspension roping to suspend the elevator car and the counterweight during construction time use of the elevator;
supporting by a first rope terminal and a second rope terminal the suspension roping;
providing a motor module comprising a motor bed, the elevator hoisting machinery mounted on the motor bed; wherein
passing a plurality of guide rails through the motor module;
during construction time use of the elevator, supporting said plurality of guide rails by a fixing bracket on which the motor module is mounted;
wherein in connection with an elevator jump, hoisting the motor module through one or more fixing brackets.

9. The method according to claim 8, wherein passing a plurality of guide rails or projections of said plurality of guide rails through the motor bed.

10. The method according to claim 8, wherein guiding the motor module comprising guide elements, such as guide shoes or guide rollers, in a controlled manner along the counterweight guide rails when hoisted; and/or
moving the motor module comprising horizontal displacement means enabling horizontal movement of the motor bed relative to the fixing bracket and adapting the motor module inside an open cross section between the fixing bracket and a wall of the hoistway; and/or
rotating an upwards rotatable front part comprised by the motor module and adapting the motor module to fit inside open cross section between the fixing bracket and a wall of the hoistway.

11. The method according to claim 8, wherein connecting the guide rails below and above the motor bed to each other through the motor bed when the elevator is driving below the motor module.

12. The method according to claim 8, wherein hoisting the second rope terminal together with the motor module, the second rope terminal being preferably supported by the motor bed.

13. The method according to claim 8, wherein feeding more belt or rope through the second rope terminal comprising an automatic rope lock device allowing opening and locking the second rope terminal; and
preferably keeping by the automatic rope lock device all ropes of the suspension roping the same length and at a constant tension.

14. The method according to claim 8, wherein passing the suspension roping downwards from the second rope terminal to suspension roping reels, preferably located at a building floor or at the bottom of the hoistway.

15. The method according to claim 8, wherein mounting the motor bed above the guide rails after finishing the final height of the hoistway.
